(19) United States
(12) Patent Application Publication
(10) Pub. No.: US 2006/0056380 A1
(43) Pub. Date: Mar. 16, 2006

(54) Radio communication device and radio communication method

(75) Inventors: Jun Mitsugi, Kanagawa-ken (JP); Koji Akita, Kanagawa-ken (JP); Ren Sakata, Kanagawa-ken (JP); Tomoya Tandai, Tokyo (JP); Naohisa Shibuya, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/086,390

(22) Filed: Mar. 23, 2005

(30) Foreign Application Priority Data
Aug. 31, 2004 (JP) 2004-251771

(51) Int. Cl. H04J 3/24

(52) U.S. Cl. 370/349

(57) ABSTRACT

There are provided a radio communication device and method including: modulating packets with a modulation scheme assigned in advance; transmitting modulated packets; receiving packets; estimating a channel state by utilizing received packets; selecting a first modulation scheme having a larger number of bits to be allocated per one symbol than the number of bits to be allocated in the modulation scheme assigned in advance, in case where the channel state satisfies a first modulation scheme change threshold, selecting a second modulation scheme having a smaller number of bits to be allocated per one symbol than the number of bits to be allocated in the modulation scheme assigned in advance, in case where the channel state satisfies a second modulation scheme change threshold; and modulating packets that satisfy an predetermined application condition, with the first or the second modulation scheme.

### CROSS-REFERENCE TO RELATED APPLICATIONS

This application claims the benefit of priority under 35USC § 119 to Japanese Patent Application No. 2004-251771, filed on Aug. 31, 2004, the entire contents of which are incorporated herein by reference.

### BACKGROUND OF THE INVENTION

1. Field of the Invention

The present invention relates to a radio communication device and a radio communication method.

2. Related Art

As modulation scheme that are used in the IEEE802.11a system, there are phase shift modulation schemes such as binary phase shift keying (BPSK) and quadrature phase shift keying (QPSK), and orthogonal amplitude modulation schemes such as 16 quadrature amplitude (QAM) and 64 QAM. Conventionally, these modulation schemes are set inherently to individual terminal units, or plural modulation schemes are used adaptively in the terminal units. According to the latter adaptive modulation scheme, when the channel quality is satisfactory, usually a modulation scheme that can express many bits in one modulation is used to increase the amount of information that can be sent at one time. When the channel quality is not satisfactory, a modulation scheme that expresses a small number of bits in one modulation is used. In other words, a channel state is measured periodically, and a data rate is changed according to the channel state.

An adaptive modulation scheme as disclosed in Japanese Patent Laid-Open Publication No. 2002-290362, for example, is publicly known. According to the technique disclosed in this literature, a modulation scheme is related to each time slot in a time division multiple access (TDMA) system, and each modulation scheme is adaptively changed according to the channel state.

As described above, according to the adaptive modulation scheme, a channel state is estimated. When the channel state is satisfactory, the modulation scheme is changed to the one that handles a larger number of bits. On the other hand, when the channel state is not satisfactory, the modulation scheme is changed to the one that handles a smaller number of bits. For example, initially, data is transmitted at 24 megabits per second (Mbps). Thereafter, when it is decided that the channel state is satisfactory, the data rate is increased to 36 Mbps for the subsequent packets. When a channel state is estimated correctly, there is no problem. However, when a wrong estimate is made about a channel state, or when the channel state changes and becomes poor after estimating the state, a change of the modulation scheme often makes it impossible to carry out communications. Particularly, when a transmission channel is not in a satisfactory state in transmitting an audio video (AV) that requires real time, making a wrong estimate that the channel state is satisfactory and changing a modulation scheme to the one that handles a larger number of bits causes a problem. In this case, a burst error occurs in information, and a moving image on the screen is frozen.

### SUMMARY OF THE INVENTION

According to an aspect of the present invention, there is provided a radio communication device comprising: a modulator that modulates packets with a modulation scheme assigned in advance; a transmitter that transmits packets modulated by the modulator; a receiver that receives packets; a channel state estimator that estimates a channel state by utilizing received packets; and a modulation scheme assigner that selects a first modulation scheme having a larger number of bits to be allocated per one symbol than the number of bits to be allocated in the modulation scheme assigned in advance, in case where the channel state satisfies a first modulation scheme change threshold, selects a second modulation scheme having a smaller number of bits to be allocated per one symbol than the number of bits to be allocated in the modulation scheme assigned in advance, in case where the channel state satisfies a second modulation scheme change threshold, and assigns the selected first or the second modulation scheme to the modulator, wherein the modulator modulates packets that satisfy a predetermined application condition, with the first or the second modulation scheme.

According to an aspect of the present invention, there is provided a radio communication device comprising: an encoder that encodes packets at a coding rate assigned in advance; a modulator that modulates the encoded packets with a modulation scheme assigned in advance; a transmitter that transmits packets modulated by the modulator; a receiver that receives packets; a channel state estimator that estimates a channel state by utilizing received packets; and an assigner that selects a combination of a coding rate and a modulation scheme that achieves a higher data rate than a data rate of a combination of the coding rate assigned in advance and the modulation scheme assigned in advance, in case where the channel state satisfies a first data rate change threshold, selects a combination of a coding rate and a modulation scheme that achieves a lower data rate than a data rate of a combination of the coding rate assigned in advance and the modulation scheme assigned in advance, in case where the channel state satisfies a second data rate change threshold, and assigns the coding rate and the modulation scheme of the selected combination to the encoder and the modulator, wherein the encoder encodes packets that satisfy an predetermined application condition, at the coding rate assigned from the assigner, and the modulator modulates the packets encoded at the assigned coding rate, with the modulation scheme assigned from the assigner.

According to an aspect of the present invention, there is provided a radio communication method comprising: modulating packets with a modulation scheme assigned in advance; transmitting modulated packets; receiving packets; estimating a channel state by utilizing received packets; selecting a first modulation scheme having a larger number of bits to be allocated per one symbol than the number of bits to be allocated in the modulation scheme assigned in advance, in case where the channel state satisfies a first modulation scheme change threshold, selecting a second modulation scheme having a smaller number of bits to be allocated per one symbol than the number of bits to be allocated in the modulation scheme assigned in advance, in case where the channel state satisfies a second modulation scheme change threshold; and modulating packets that satisfy an predetermined application condition, with the first or the second modulation scheme.

### BRIEF DESCRIPTION OF THE DRAWINGS

FIG. 1 is a block diagram showing a configuration of a radio terminal according to embodiment of the present invention;

FIG. 2 is a diagram of an example of a packet format;

FIG. 3 is a flowchart showing a flow of a basic processing carried out by the radio terminal shown in FIG. 1;

FIG. 4 is a flowchart for explaining processing steps carried out by an access point AP; FIG. 5 is a diagram showing a state that packets to be transmitted at 24 Mbps and packets to be transmitted at 36 Mbps are mixed;

FIG. 6 is a diagram for explaining a method of determining a proportion of packets to which a data rate is to be increased;

FIG. 7 is a flowchart for explaining a method of selecting packets to which a data rate is to be increased;

FIG. 8 is a diagram for explaining a method of determining a data rate based on a value of Na/Np;

FIG. 9 is a flowchart for explaining other processing steps carried out by the access point AP;

FIG. 10 is a block diagram showing a configuration of a radio terminal according to a third embodiment of the present invention;

FIG. 11 is a diagram for explaining a method of determining a mixture rate by using a channel response;

FIG. 12 is an IQ constellation for explaining a method of calculating demodulation precision; and

FIG. 13 is a diagram for explaining a relationship between priorities assigned to packets and data rates.

### DETAILED DESCRIPTIONS OF THE INVENTION

Embodiments of the present invention are explained in detail below with reference to drawings.

### First Embodiment

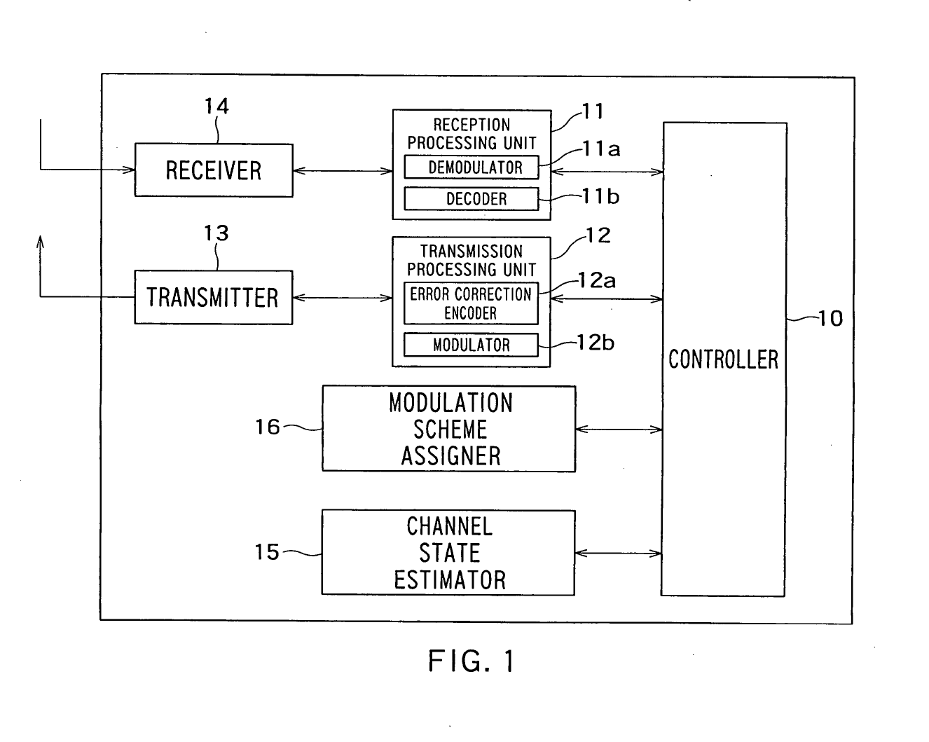

FIG. 1 is a block diagram showing a configuration of a radio terminal according to embodiment of the present invention.

This radio terminal includes a controller 10, a reception processing unit 11, a transmission processing unit 12, a transmitter 13, a receiver 14, a channel state estimator 15, and a modulation scheme assigner 16.

The transmission processing unit 12 has an error correction encoder 12a that carries out an error correction encoding of transmission data that is input from the controller 10, and a modulator 12b that executes a primary modulation and an orthogonal frequency division multiplexing (OFDM) modulation.

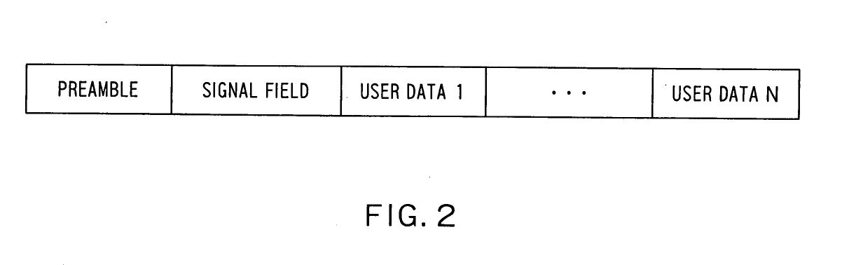

FIG. 2 shows an example of a packet format that is used in an OFDM transmission scheme.

In FIG. 2, a preamble signal as a known signal is arranged at the head OFDM symbol of the packet. The next OFDM symbol includes information concerning this packet, that is, information of a data rate and a data length. This part is called a signal field. The subsequent OFDM symbols include user data 1 to user data N. Each OFDM symbol includes plural sub-carriers.

The present radio terminal can transmit data at eight data rates including 6 Mbps, 9 Mbps, 12 Mbps, 18 Mbps, 24 Mbps, 36 Mbps, 48 Mbps, and 54 Mbps. The transmission processing unit 12 encodes and modulates data according to a coding rate and a modulation scheme (i.e., a primary modulation scheme) that are determined in advance corresponding to each data rate. In other words, when the data rate is 6 Mbps, a coding rate is ½, and a BPSK modulation scheme is used. When the data rate is 9 Mbps, a coding rate is ¾, and a BPSK modulation scheme is used. When the data rate is 12 Mbps, a coding rate is ½, and a QPSK modulation scheme is used. When the data rate is 18 Mbps, a coding rate is ¾, and a QPSK modulation scheme is used. When the data rate is 24 Mbps, a coding rate is ½, and a 16 QAM modulation scheme is used. When the data rate is 36 Mbps, a coding rate is ¾, and a 16 QAM modulation scheme is used. When the data rate is 48 Mbps, a coding rate is ⅔, and a 64 QAM modulation scheme is used. When the data rate is 54 Mbps, a coding rate is ¾, and a 64 QAM modulation scheme is used.

The transmitter 13 is input with transmission data (i.e., a packet) from the transmission processing unit 12, and transmits this input packet to other device.

The receiver 14 receives a packet from the other device, and passes this received packet to the reception processing unit 11.

The reception processing unit 11 carries out an OFDM demodulation. The reception processing unit 11 includes a demodulator 11a having plural demodulating units, and a decoder 11b. The reception processing unit 11 checks a signal field of a packet that is received by the receiver 14. Based on this check, the reception processing unit 11 recognizes a modulation scheme and a data length of the user data. The reception processing unit 11 demodulates the user data using a corresponding demodulating unit. The decoder 11b decodes the demodulated data, and passes the decoded demodulated data to the controller 10.

The channel state estimator 15 estimates a channel state, using a packet received by the receiver 14, and passes a result of the estimate to the modulation scheme assigner 16.

The modulation scheme assigner 16 determines whether a data rate (i.e., a modulation scheme and a coding rate) can be changed, based on the channel state estimated by the channel state estimator 15. When the data rate can be changed, the modulation scheme assigner 16 selects a data rate that is different from the one currently used, from among the eight data rates. But, It is assumed that the data rate of the signal field is fixed to 6 Mbps. Basically, when the data rate becomes higher, demodulation performance to noise becomes poorer.

The modulation scheme assigner 16 also determines a proportion of packets (=number of application packets/total number of packets to be transmitted) to which the selected data rate is applied, based on the estimate result of the transmission channel state.

The modulation scheme assigner 16 informs the selected data rate (i.e., the modulation scheme and the coding rate) and the determined proportion, of the transmission processing unit 12.

The transmission processing unit 12 mixes packets of the data rate (i.e., the coding rate and the modulation scheme) selected by the modulation scheme assigner 16, at the proportion determined by the modulation scheme assigner 16, and transmits the mixed packets. To packets except for the packets to which the selected data rate is applied, a data rate that is already executed is applied.

The controller 10 controls the reception processing unit 11, the transmission processing unit 12, the channel state estimator 15, and the modulation scheme assigner 16. AT the transmission, the controller 10 receives transmission data from an application not shown, and passes this transmission data to the transmission processing unit 12. At the reception, the controller 10 receives demodulated and decoded data from the reception processing unit 11, and passes this data to the application.

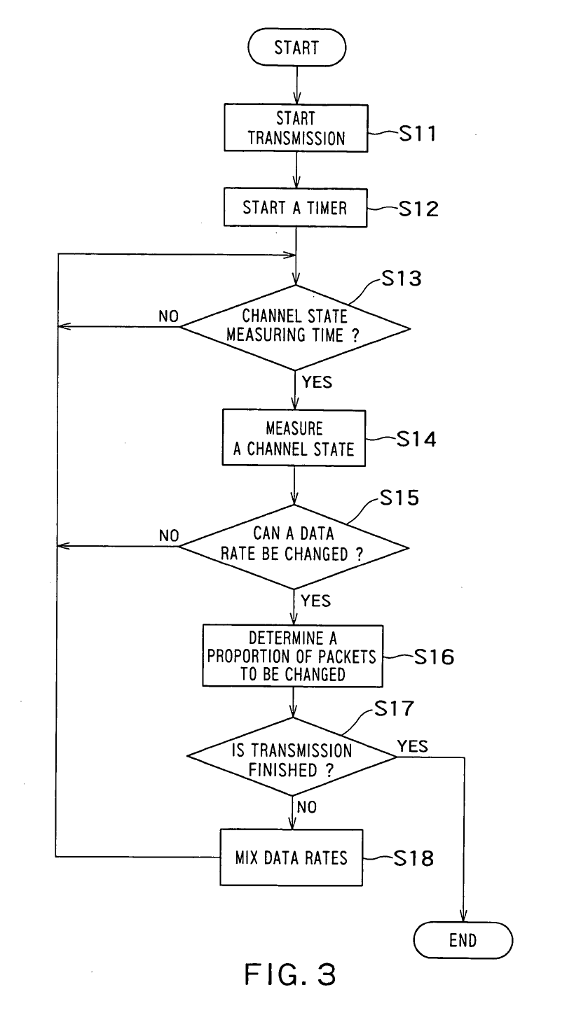

FIG. 3 is a flowchart showing a flow of a adaptive modulation processing carried out by the radio terminal shown in FIG. 1.

The radio terminal starts a transmission processing using a data rate (i.e., a coding rate and a modulation scheme) assigned in advance (step S11), and starts a timer not shown (step S12). The channel state estimator 15 estimates a channel state at every predetermined time (step S13, and step S14). In this estimate operation, a method explained in subsequent embodiment or a known method is used.

The channel state estimator 15 passes a result of the estimate to the modulation scheme assigner 16. The modulation scheme assigner 16 determines whether a data rate can be changed, based on the estimate result received from the channel state estimator 15 (step S15).

The modulation scheme assigner 16 determines a new data rate when a data rate can be changed (for example, the data rate is increased by one stage) (YES at step S15). The modulation scheme assigner 16 determines a proportion of packets to which the changed data rate is to be applied, based on the estimate result (step S16). The modulation scheme assigner 16 informs the determined data rate and the determined proportion of packets, of the transmission processing unit 12. The transmission processing unit 12 applies the data rate (i.e., the coding rate and the modulation scheme) assigned from the modulation scheme assigner 16, to the packets at the assigned proportion (NO at step S17, and step S18). But, when there is no packet to be transmitted (YES at step S17), the present adaptive modulation processing is finished.

Thereafter, or when a data rate cannot be changed (NO at step S15), the process returns to step S13, and the channel state estimator 15 estimates a channel state at each predetermined time.

As described above, according to the present embodiment, a new data rate and a proportion of packets to which the new data rate is applied are determined based on a channel state. The new data rate is applied to the packets at the determined proportion. Therefore, occurrence of a burst error can be decreased as far as possible even when an estimate of a channel state is wrong or when a channel state becomes poor after changing a modulation scheme.

### Second Embodiment

In the present second embodiment, a detailed method of estimating a channel state is explained. The estimating method according to the present embodiment is explained in detail below by using the radio terminal shown in FIG. 1.

The channel state estimator 15 calculates a rate of a number of acknowledgement (ACK) packets to a number of transmitted packets. This rate indicates a channel state. The modulation scheme assigner 16 receives a result of the calculation from the channel state estimator 15, compares the calculation result with a threshold value, and determines whether a data rate can be changed. When the data rate can be changed, the modulation scheme assigner 16 determines a data rate (i.e., a coding rate and a modulation scheme) to be applied newly, and a proportion of packets to which this data rate is to be applied. A concrete example is explained in detail below.

Assume that a radio local area network (LAN) terminal that has the configuration shown in FIG. 1 (an access point AP) transmits real time image data to a radio LAN terminal (a station STA).

Assume that the access point AP transmits image data at a minimum data rate, for example, 24 Mbps (i.e., the coding rate ½, and the 16 QAM modulation scheme), that is necessary to transmit the real time image data.

The station STA checks an error based on an error detecting code (CRC) that is included in a received packet. When there is no error, the station STA returns an ACK to the access point AP. When there is an error, the station STA does not return the ACK.

When the access point AP receives an ACK from the station STA, the access point AP transmits the next packet. When a time out occurs without receiving an ACK, the access point AP re-transmits the packet. But, the packet is re-transmitted only once. When there is no ACK to the re-transmitted packet, the access point AP transmits the next packet.

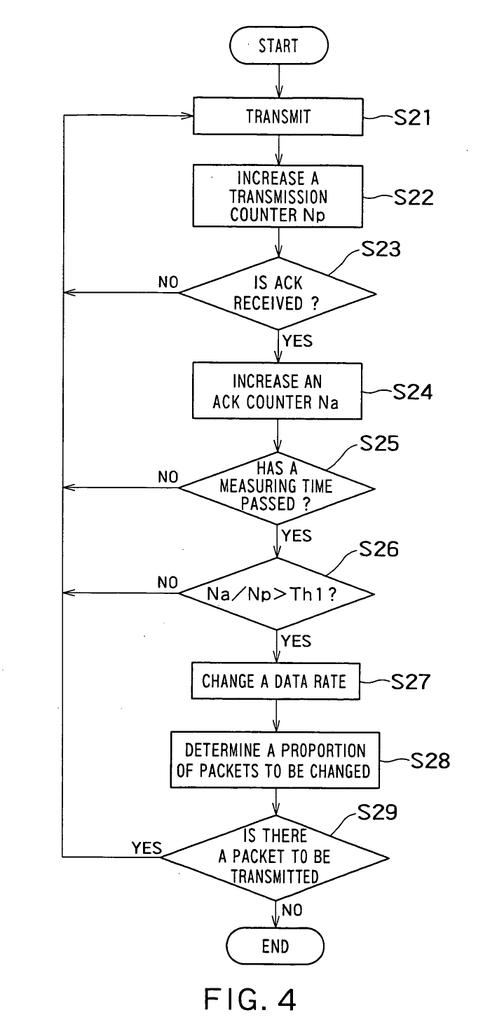

FIG. 4 is a flowchart for explaining processing steps carried out by the access point AP.

In the access point AP, the channel state estimator 15 increases a transmission counter Np by one each time when a packet is transmitted (steps S21 and S22).

Each time when an ACK is received (YES at step S23), the channel state estimator 15 increases an ACK counter Na by one (step S24).

When a time out occurs without receiving an ACK, the access point AP re-transmits a packet. When there is no ACK even after the packet is transmitted again (NO at step S23), the access point AP transmits the next packet.

The processing at step S21 to step S24 is repeated until when a certain time (i.e., a measuring time) T1 passes (NO at step S25). Each time when the certain time T1 passes (YES at step S25), the channel state estimator 15 calculates a rate Na/Np, that is a rate of the number of ACKs to the number of transmitted packets, and outputs this calculation result to the modulation scheme assigner 16.

The modulation scheme assigner 16 compares the calculated result (Na/Np) received from the channel state estimator 15 with a threshold value Th1 (step S26).

When Na/Np>Th1 (YES at step S26), the modulation scheme assigner 16 decides that the channel state is satisfactory (the channel state satisfies a first modulation scheme change threshold, a first coding rate change threshold or a first data rate change threshold), that is, the modulation scheme assigner 16 decides that a data rate can be changed, and determines to increase the data rate by one stage, for example (step S27).

On the other hand, when Na/Np≦Th1 (NO at step S26), the modulation scheme assigner 16 decides that the channel state is poor, that is, the modulation scheme assigner 16 decides that the data rate cannot be changed. After the measuring time T1 passes, the modulation scheme assigner 16 decides again whether Na/Np>Th1 is satisfied. Here, assume that the modulation scheme assigner 16 decides that the data rate can be changed, and determines to increase the data rate by one stage.

The modulation scheme assigner 16 determines a proportion of packets to which the data rate is increased, that is, a proportion of packets that are to be transmitted at 36 Mbps that is one stage higher than 24 Mbps (step S28). When there are packets to be transmitted (YES at step S29), the access point AP transmits the packets while changing the data rate according to the proportion of packets determined by the modulation scheme assigner 16. In other words, the access point AP transmits a mixture of packets that are transmitted at 24 Mbps and packets that are transmitted at 36 Mbps. FIG. 5 shows a state of transmitting the mixture of packets that are transmitted at 24 Mbps and packets that are transmitted at 36 Mbps.

On the other hand, when there is no packet to be transmitted (NO at step S29), the access point AP finishes the processing.

A method of determining a proportion of packets to which the data rate is to be increased (i.e., the proportion of packets to which 36 Mbps is applied) is explained below, as an example.

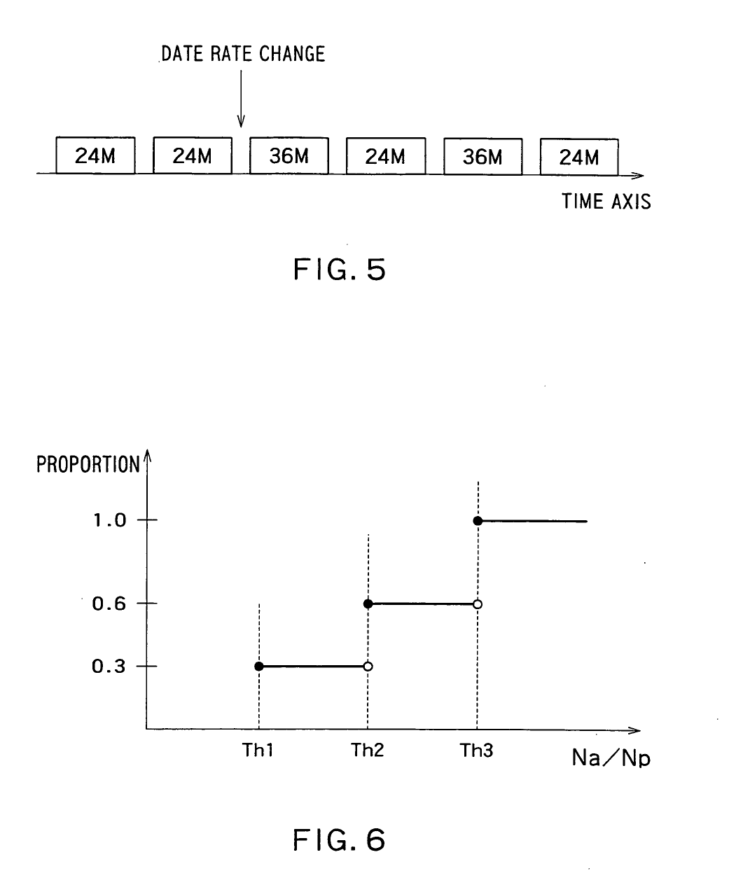

FIG. 6 is a diagram for explaining a method of determining a proportion of packets to which a data rate is to be increased.

A proportion of packets to which a data rate is increased can be determined using a rate Na/Np, that is a rate of the number of ACKs to the number of transmitted packets (refer to the abscissa axis of a graph shown in FIG. 6).

This is explained more specifically below.

First, further threshold values Th2 and Th3 are prepared. Here, 1>Th3>Th2>Th1.

When Th2>Na/Np>Th1, 30 percent of the total packets are transmitted at 36 Mbps.

When Th3≧Na/Np≧Th2, 60 percent of the total packets are transmitted at 36 Mbps.

When Na/Np≧Th3, the total packets are transmitted at 36 Mbps.

A method of selecting packets to which a data rate is increased is explained next.

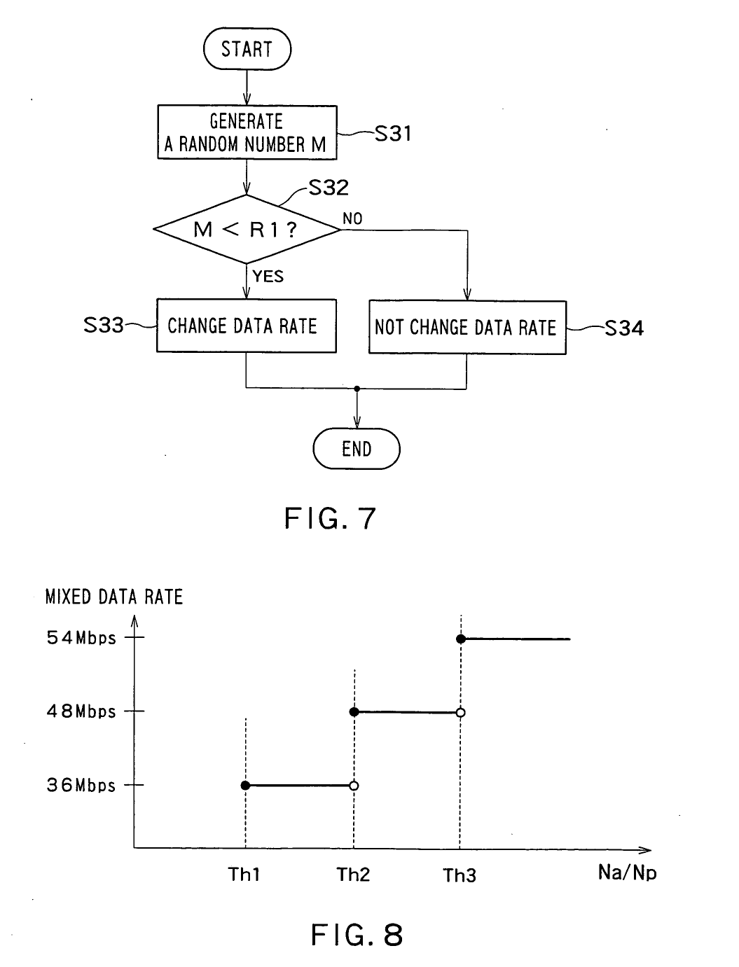

FIG. 7 is a flowchart for-explaining a method of selecting packets to which a data rate is to be increased.

Assume that the modulation scheme assigner 16 determines to transmit R1 packets out of ten packets at 36 Mbps, at step S28 in FIG. 4.

The modulation scheme assigner 16 generates a random number M (where M is 0 to 9) for each transmission of packets (step S31). When M<R1 (YES at step S32), the modulation scheme assigner 16 determines to transmit the packet at 36 Mbps (step S33). In other cases, the modulation scheme assigner 16 determines to transmit the packet at 24 Mbps (step S34).

The packets transmitted at 36 Mbps are more easily affected by noise and interference than the packets transmitted at 24 Mbps, and errors can be easily generated. However, since the number of packets to be transmitted at 36 Mbps is limited to a constant proportion in the above way, the occurrence of burst errors can be prevented as far as possible even when an error occurs in the packets transmitted at 36 Mbps.

In the above example, though transmitting packets at a data rate that is one stage higher is explained, transmitting packets at a data rate that is plural stages higher, that is, 48 Mbps (i.e., the coding rate ⅔, and the 64 QAM modulation scheme) can be also possible. In the above example, though a packet mixture rate is determined based on the threshold values Th1 to Th3, the packet mixture rate can be constant (for example, 50 percent).

Here, a new data rate can be also determined according to the value of Na/Np.

FIG. 8 is a diagram for explaining a method of determining a data rate based on a value of Na/Np, assuming that a packet mixture rate is constant (for example, 50 percent).

In this example, when Th2>Na/Np≧Th1, the data rate is set to 36 Mbps.

When Th3>Na/Np≧Th2, the data rate is set to 48 Mbps.

When Na/Np≧Th3, the data rate is set to 54 Mbps.

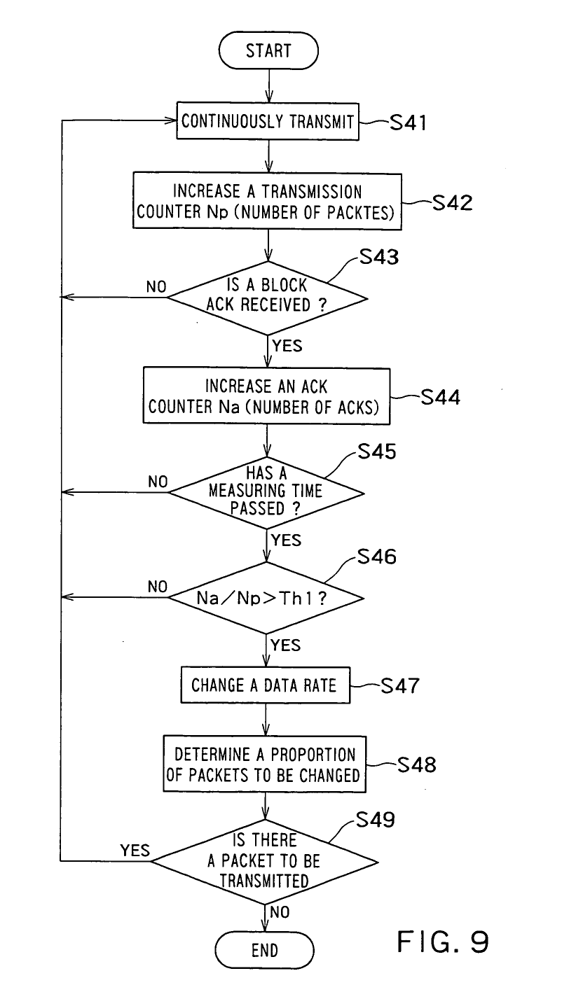

It is explained above that after receiving an ACK of a transmitted packet, the access point AP transmits the next packet. Alternatively, the access point AP can continuously transmit plural packets, and receive a result of an error check (i.e., a block ACK) for the plural packets from the STA. Each time when packets are continuously transmitted, the access point AP increments the transmission counter Np by the number of the transmitted packets. Each time when a block ACK is received, the access point AP increments the ACK counter Na by the number of acknowledgements included in the block ACK, thereby calculating Na/Np. FIG. 9 shows the above processing flow in detail.

As shown in FIG. 9, each time when plural packets are continuously transmitted, the channel state estimator 15 in the access point AP increments the transmission counter Np by the number of the transmitted packets (steps S41, and S42).

Each time when a block ACK is received (YES at step S43), the channel state estimator 15 increases the ACK counter Na by the number of acknowledgements included in the received block ACK (step S44). When error packets are detected at the station STA, the access point AP re-transmits only the packets whose errors are detected. But, the packets are re-transmitted only once.

When a time out occurs without receiving a block ACK, the access point AP re-transmits the packets. When there is no block ACK even after the packets are re-transmitted (NO at step S43), the access point AP transmits the next packets.

The processing at step S41 to step S44 is repeated until when a certain time (i.e., the measuring time) T1 passes (NO at step S45). Each time when the certain time T1 passes (YES at step S45), the channel state estimator 15 calculates the rate Na/Np, that is a rate of the number of ACKs to the number of transmitted packets, and outputs this calculation result to the modulation scheme assigner 16.

The modulation scheme assigner 16 compares the calculated result (Na/Np) received from the channel state estimator 15 with the threshold value Th1 (step S46).

When Na/Np>Th1 (YES at step S46), the modulation scheme assigner 16 decides that the channel state is satisfactory, that is, the modulation scheme assigner 16 decides that a data rate can be changed, and determines to increase the data rate by a predetermined number of stages (step S47).

On the other hand, when Na/Np≦Th1 (NO at step S46), the modulation scheme assigner 16 decides that the channel state is poor, that is, the modulation scheme assigner 16 decides that the data rate cannot be changed. After the measuring time T1 passes, the modulation scheme assigner 16 decides again whether Na/Np>Th1 is satisfied. Here, assume that the modulation scheme assigner 16 decides that the data rate can be changed and determines to increase the data rate by a predetermined number of stages.

The modulation scheme assigner 16 determines a proportion of packets to which the data rate is increased (step S48). When there are packets to be transmitted (YES at step S49), the access point AP transmits the packets while changing the data rate according to the proportion of packets determined by the modulation scheme assigner 16.

On the other hand, when there is no packet to be transmitted (NO at step S49), the access point AP finishes the processing.

In the above explanation, a data rate is changed when it is decided that the state of a transmission channel is satisfactory. The method according to the present embodiment can be also applied when it is decided that the state of a transmission channel is poor (the channel state satisfies a second modulation scheme change threshold, a second encoding rate change threshold or a second data rate change threshold). In this case, the data rate is lowered to a part of packets in the same way, thereby controlling the transmission of packets. The data rate may be lowered to whole packets.

As explained above, according to the present embodiment, a channel state is estimated based on the number of ACKs relative to the number of transmitted packets. Therefore, a channel state can be estimated properly.

### Third Embodiment

In the above second embodiment, the number of received ACKs relative to the number of transmitted packets is used as a method of estimating a channel state. In the third embodiment, other method of estimating a channel state is explained.

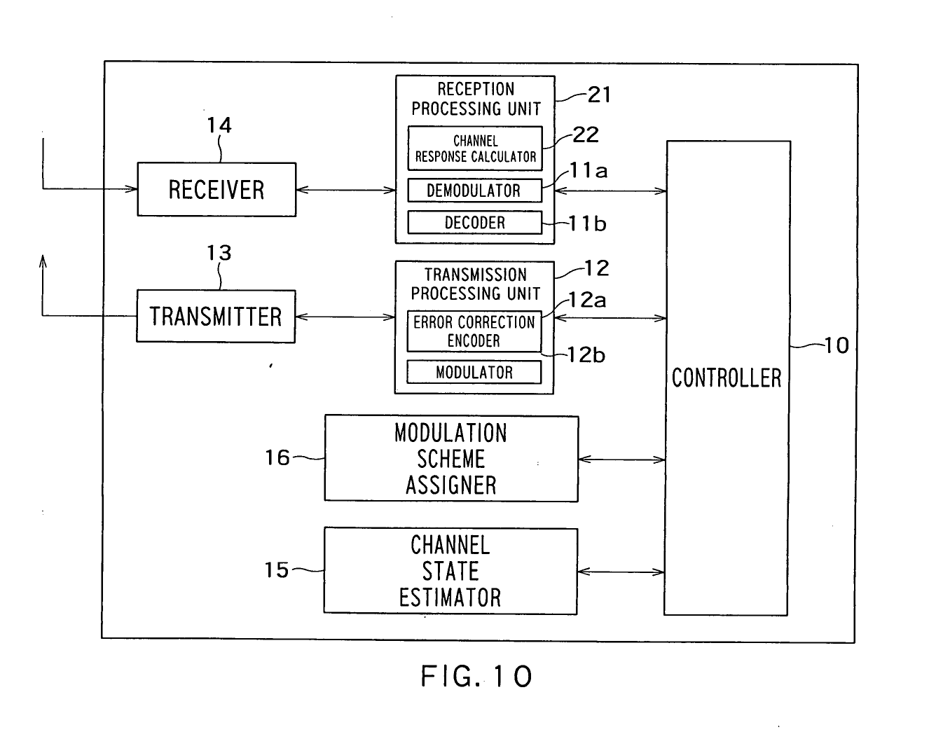

FIG. 10 is a block diagram showing a configuration of a radio terminal according to the present embodiment.

In this radio terminal, a reception processing unit 21 has a channel response calculator 22. Other configurations are similar to those in FIG. 1. Constituent elements identical with those shown in FIG. 1 are assigned with the same reference numerals, and their explanation is omitted.

The channel response calculator 22 estimates a channel response using a preamble signal in which a known pattern is embedded, in a received packet signal, and outputs the estimated result to the channel state estimator 15. The channel state estimator 15 estimates a channel state by using this channel response.

More specifically, a channel response (in this example, a rate of reception power to predetermined power) is estimated for each sub-carrier carrying the preamble signal (OFDM symbol). The channel state estimator 15 estimates a channel state based on an average value calculated from channel responses of respective sub-carriers and minimum value of channel responses of respective sub-carriers. When all value of the channel responses estimated for each sub-carrier is substantially equal, it is estimated that the transmission channel is relatively satisfactory.

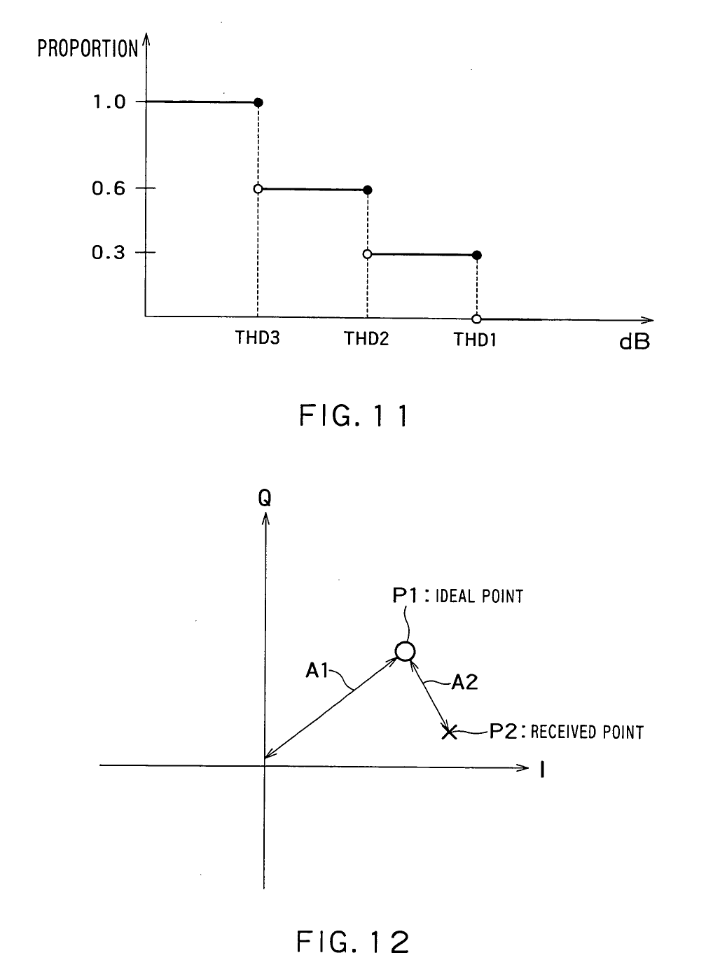

FIG. 11 is a diagram for explaining a method of determining a mixture rate by using a channel response.

The abscissa axis is 20 Log average value/minimum value, where threshold values THD3, THD2, and THD1 are 3 decibels (dB), 6 dB, and 10 dB, respectively. The modulation scheme assigner 16 receives average value and minimum value from the channel state estimator 15. The vertical axis shows a proportion of packets to which a data rate is increased.

In this example, when the value of the abscissa axis≦THD3, a proportion of packets to which a data rate is increased is 1 (i.e., 100%). When THD3<the value of the abscissa axis≦THD2, a proportion of packets to which a data rate is increased is 0.6 (i.e., 60%). When THD2<the value of the abscissa axis≦THD1, a proportion of packets to which a data rate is increased is 0.3 (i.e., 30%). When THD1<the value of the abscissa axis, it is decided that a channel state is not particularly satisfactory, and the data rate is not changed.

In the above explanation, a mixture rate is determined using the average value and the minimum value. Alternatively, a mixture rate can be determined using maximum value and minimum value, or using average value and maximum value.

As explained above, according to the present embodiment, a channel state is estimated based on a channel response. Therefore, the state of a transmission channel can be estimated properly.

### Fourth Embodiment

In the present fourth embodiment, further other method of estimating a channel state is explained.

According to the present embodiment, demodulation precision is calculated based on a reception signal and an in-phase/quadrature (IQ) constellation, and this calculation result is used to estimate a channel state. The method according to the present embodiment is explained in detail below.

FIG. 12 is the IQ constellation for explaining the method of calculating demodulation precision.

A distance from the origin to an ideal point P1 is set as A1. A distance from the ideal point P1 to a certain sample point (i.e., a received point) P2 is set as A2. In this case, demodulation precision at a certain sample point becomes 20 Log (A2/A1). The channel state estimator 15 obtains the ideal point P1 and the sample point P2 from the demodulator 11a, and uses these points to determine the demodulation precision. This demodulation precision is obtained for each sub-carrier that constitutes 1 OFDM symbol. Average demodulation precision of some or all of OFDM symbols in the packet is calculated.

For example, according to IEEE802.11a, 48 sub-carriers are included in 1 OFDM symbol. Therefore, demodulation precision becomes an average value EVM of the 48 sub-carriers. An average value of N number of EVMs is calculated, in the case where N is a number of OFDM symbols (here, user data symbols). The modulation scheme assigner 16 obtains this average value from the channel state estimator 15, and determines a mixture rate of packets by using the obtained average value.

For example, in FIG. 11, assume that THD1=−10 dB, THD2=−15 dB, and THD3=−20 dB. The, when THD1≧the average value>TH2, the mixture rate is 0.3. When THD2≧the average value>TH3, the mixture rate is 0.6. When THD3≧the average value, the mixture rate is 1.

As explained above, according to the present embodiment, because a channel state is estimated based on the demodulation precision, the channel state can be estimated properly.

### Fifth Embodiment

In the second embodiment, a method of randomly selecting packets to which a data rate is increased is explained. In the present fifth embodiment, other method of selecting packets to which a data rate is changed is explained.

Assume that a priority is set to each transmission packet. A packet of a high priority is transmitted at a low data rate, thereby increasing error resistance of packets having a high priority. An example of this method is explained in detail below.

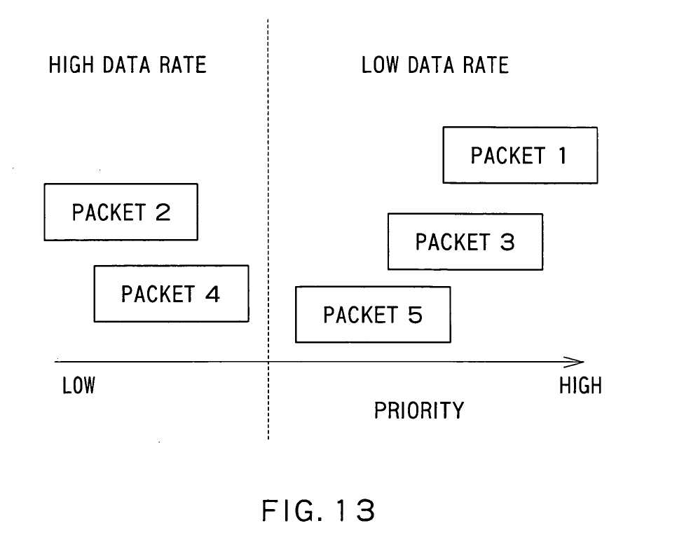

FIG. 13 is a diagram explaining a relationship between priorities assigned to packets and data rates.

Five packets 1 to 5 to be transmitted are shown in FIG. 13. A priority is set to each packet. Assume that the packets have priorities in the order of the packet 1, the packet 3, the packet 5, the packet 4, and the packet 2. The packets are transmitted in the order of the packet 1, the packet 2, the packet 3, the packet 4, and the packet 5.

Assume that a proportion of packets that are transmitted at a high data rate is determined as 40 percent. In other words, of the five packets, two packets are transmitted at a high data rate, and the remaining three packets are transmitted at a low data rate.

In this case, the packet 2 and the packet 4 having low priorities are selected as the packets that are to be transmitted at a high data rate. The rest of the packets, that is, the packet 1, the packet 3, and the packet 5 are to be transmitted at a low data rate.

When plural packets have the same priority and compete with each other, packets selected at random are transmitted at a high data rate or a low data rate. For example, assume that the packets 1, 3, 4, and 5 have the same priority, and the packet 2 has a lower priority. In this case, one of the packets 1, 3, 4, and 5 is selected at random. This selected packet and the packet 2 are transmitted at a high data rate, and the rest of the packets are transmitted at a low data rate.

As explained above, according to the present embodiment, packets to which a data rate is changed are selected based on the priorities of the packets. Therefore, by transmitting the packets of high priorities at a low data rate, it is possible to prevent loss of data having high priorities as far as possible.

What is claimed is:

1. A radio communication device comprising:
a modulator that modulates packets with a modulation scheme assigned in advance;
a transmitter that transmits packets modulated by the modulator;
a receiver that receives packets;
a channel state estimator that estimates a channel state by utilizing received packets; and
a modulation scheme assigner that
selects a first modulation scheme having a larger number of bits to be allocated per one symbol than the number of bits to be allocated in the modulation scheme assigned in advance, in case where the channel state satisfies a first modulation scheme change threshold,
selects a second modulation scheme having a smaller number of bits to be allocated per one symbol than the number of bits to be allocated in the modulation scheme assigned in advance, in case where the channel state satisfies a second modulation scheme change threshold, and
assigns the selected first or the second modulation scheme to the modulator,
wherein the modulator modulates packets that satisfy a predetermined application condition, with the first or the second modulation scheme.

2. The radio communication device according to claim 1, further comprising:
an encoder that encodes packets before modulation at a coding rate assigned in advance, wherein
the modulation scheme assigner
selects a first coding rate which is lower than the coding rate assigned in advance, in case where the channel state satisfies a first coding rate change threshold,
selects a second coding rate which is higher than the coding rate assigned in advance, in case where the channel state satisfies a second coding rate change threshold, and
assigns the selected first or the second coding rate to the encoder,
wherein the encoder encodes packets that satisfy the predetermined application condition, at the first or the second coding rate.

3. The radio communication device according to claim 1, wherein
the channel state estimator estimates the channel state based on the number of packets transmitted by the transmitter and the number of received acknowledgement packets which respond to the transmitted packets.

4. The radio communication device according to claim 2, wherein
the channel state estimator estimates the channel state based on the number of packets transmitted by the transmitter and the number of received acknowledgement packets which respond to the transmitted packets.

5. The radio communication device according to claim 1, further comprising:
a channel response calculator that calculates the channel response based on a known signal included in the packet received by the receiver, wherein
the channel state estimator estimates a channel state based on the channel response calculated by the channel response calculator.

6. The radio communication device according to claim 2, further comprising:
a channel response calculator that calculates the channel response based on a known signal included in the packet received by the receiver, wherein
the channel state estimator estimates a channel state based on the channel response calculated by the channel response calculator.

7. The radio communication device according to claim 1, further comprising:
a demodulator that demodulates each sub-carrier constituting the packet received by the receiver, by mapping a received point of each sub-carrier to any one of reference points on an IQ constellation, wherein
the channel state estimator estimates the channel state based on a distance between the received point and the reference point and an amplitude of the reference point.

8. The radio communication device according to claim 2, further comprising:
a demodulator that demodulates each sub-carrier constituting the packet received by the receiver, by mapping a received point of each sub-carrier to any one of reference points on an I-Q constellation, wherein
the channel state estimator estimates the channel state based on a distance between the received point and the reference point and an amplitude of the reference point.

9. The radio communication device according to claim 1, wherein
the modulator modulates packets with the first or the second modulation scheme according to an application proportion condition that indicates a proportion of the packets to which the first or the second modulation scheme is applied, as the predetermined application condition.

10. The radio communication device according to claim 9, wherein
the channel state estimator represents a result of estimating the channel state by a numerical value,
the modulation scheme assigner obtains the application proportion condition by relating the numerical value to mapping information that relates a plurality of numeric range partitioned by threshold values and application proportion conditions, and assigns the obtained application proportion condition to the modulator, and
the modulator modulates the packets with the first or the second modulation scheme according to the assigned application proportion condition.

11. The radio communication device according to claim 9, wherein
in order to modulate the packets according to the application proportion condition, the modulator generates a random number before modulating the packet, modulates this packet with the first or the second modulation scheme in case where the generated random number satisfies a predetermined threshold value, and modulates this packet with the modulation scheme assigned in advance in case where the generated random number does not satisfy the predetermined threshold value.

12. The radio communication device according to claim 9, wherein
the packets are provided with priorities, and
in order to modulate the packets according to the application proportion condition, the modulator modulates the packet with the first or the second modulation scheme in case where the priority of the packet satisfies a predetermined threshold, and modulates the packet with the modulation scheme assigned in advance in case where the priority of the packet dose not satisfy the predetermined threshold.

13. The radio communication device according to claim 2, wherein
the encoder encodes packets according to an application proportion condition that indicates a proportion of packets to which the first or the second coding rate is applied, as the predetermined application condition.

14. The radio communication device according to claim 13, wherein
the channel state estimator represents a result of estimating the channel state by a numerical value,
the modulation scheme assigner obtains the application proportion condition by relating the numerical value to mapping information that relates a plurality of numeric ranges partitioned by threshold values and application proportion conditions, and assigns the obtained application proportion condition to the encoder, and
the encoder encodes the packets at the first or the second coding rate according to the assigned application proportion condition.

15. The radio communication device according to claim 13, wherein.
in order to encode the packets according to the application proportion condition, the encoder generates a random number before encoding the packet, encodes this packet at the first or the second coding rate in case where the generated random number satisfies a predetermined threshold value, and encodes this packet at the coding rate assigned in advance in case where the generated random number does not satisfy the predetermined threshold value.

16. The radio communication device according to claim 13, wherein
the packets are provided with priorities, and
in order to encode the packets according to the application proportion condition, the encoder encodes the packet at the first or the second encoding rate in case where the priority of the packet satisfies a predetermined threshold, and encodes the packet at the encoding rate assigned in advance in case where the priority of the packet dose not satisfy the predetermined threshold.

17. A radio communication device comprising:
an encoder that encodes packets at a coding rate assigned in advance;
a modulator that modulates the encoded packets with a modulation scheme assigned in advance;
a transmitter that transmits packets modulated by the modulator;
a receiver that receives packets;
a channel state estimator that estimates a channel state by utilizing received packets; and
an assigner that
selects a combination of a coding rate and a modulation scheme that achieves a higher data rate than a data rate of a combination of the coding rate assigned in advance and the modulation scheme assigned in advance, in case where the channel state satisfies a first data rate change threshold,
selects a combination of a coding rate and a modulation scheme that achieves a lower data rate than a data rate of a combination of the coding rate assigned in advance and the modulation scheme assigned in advance, in case where the channel state satisfies a second data rate change threshold, and
assigns the coding rate and the modulation scheme of the selected combination to the encoder and the modulator,
wherein the encoder encodes packets that satisfy an predetermined application condition, at the coding rate assigned from the assigner, and
the modulator modulates the packets encoded at the assigned coding rate, with the modulation scheme assigned from the assigner.

18. A radio communication method comprising:
modulating packets with a modulation scheme assigned in advance;
transmitting modulated packets;
receiving packets;
estimating a channel state by utilizing received packets;
selecting a first modulation scheme having a larger number of bits to be allocated per one symbol than the number of bits to be allocated in the modulation scheme assigned in advance, in case where the channel state satisfies a first modulation scheme change threshold, selecting a second modulation scheme having a smaller number of bits to be allocated per one symbol than the number of bits to be allocated in the modulation scheme assigned in advance, in case where the channel state satisfies a second modulation scheme change threshold; and
modulating packets that satisfy an predetermined application condition, with the first or the second modulation scheme.

19. The radio communication method according to claim 18, further comprising:
encoding packets at a coding rate assigned in advance, before modulating the packets;
selecting a first coding rate which is lower than the coding rate assigned in advance, in case where the channel state satisfies a first coding rate change threshold, and selecting a second coding rate which is higher than the coding rate assigned in advance, in case where the channel state satisfies a second coding rate change threshold; and
encoding packets that satisfy the predetermined application condition, at the first or the second coding rate.
